(19) United States
(12) Patent Application Publication
(10) Pub. No.: US 2021/0167542 A1
(43) Pub. Date: Jun. 3, 2021

(54) CONNECTOR

(71) Applicant: SUMITOMO WIRING SYSTEMS, LTD., Mie (JP)

(72) Inventor: Kazumi OKA, Mie (JP)

(21) Appl. No.: 17/098,665

(22) Filed: Nov. 16, 2020

(30) Foreign Application Priority Data
Nov. 29, 2019 (JP) 2019-216126

(51) Int. Cl. H01R 13/436

(52) U.S. Cl. CPC H01R 13/436

(57) ABSTRACT

A connector is provided with first terminal fittings 50, and a first housing 10A for accommodating the first terminal fittings 50. The first housing 10A includes cavities 12 inside which the first terminal fittings 50 are arranged, and deflectable locking lances 12 projecting into the cavities 12 to lock the first terminal fittings 50. The locking lance 20 includes a protrusion 25 projecting toward a side opposite to the cavity 12. The protrusion 25 has an elevation surface 26 facing a front surface side of the first housing 10A with the locking lance 20 deflected.

### CROSS-REFERENCE TO RELATED APPLICATIONS

This application is based on and claims priority from Japanese Patent Application No. 2019-216126, filed on Nov. 29, 2019, with the Japan Patent Office, the disclosure of which is incorporated herein in their entireties by reference.

### TECHNICAL FIELD

The present disclosure relates to a connector.

### BACKGROUND

A connector disclosed in Japanese Patent Laid-Open Publication No. 2019-021386 includes a plurality of terminal accommodation chambers, a plurality of detection spaces corresponding to the respective terminal accommodation chambers and a plurality of locking lances. When being inserted into the detection space, a detection pin reaches a predetermined insertion position without being hindered by the locking lance if a terminal is accommodated at a proper position. On the other hand, if the terminal is not accommodated at the proper position, the detection pin does not reach the predetermined insertion position by being hindered by the locking lance. Connectors of Japanese Patent Laid-Open Publication No. 2007-172998 and Japanese Patent Laid-Open Publication No. 2004-241205 are similarly configured to include locking lances for retaining terminal fittings by being deflected and deformed.

### SUMMARY

In such a connector of Japanese Patent Laid-Open Publication No. 2019-021386, the detection pin is configured to contact the tip of the locking lance from front. Since this tip of the locking lance is shaped to project, the detection pin comes into pinpoint contact with the tip of the locking lance. Thus, there is a problem that a state of the detection pin in contact with the tip of the locking lance is not stable.

The present disclosure was completed on the basis of the above situation and aims to provide a connector capable of satisfactorily detecting an incompletely inserted state of a terminal fitting.

The present disclosure is directed to a connector with a terminal fitting and a housing for accommodating the terminal fitting, wherein the housing includes a cavity, the terminal fitting being arranged inside the cavity, and a deflectable locking lance projecting into the cavity to lock the terminal fitting, the locking lance includes a protrusion projecting toward a side opposite to the cavity, and the protrusion has an elevation surface facing a front surface side of the housing with the locking lance deflected.

According to the present disclosure, it is possible to provide a connector capable of satisfactorily detecting an incompletely inserted state of a terminal fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of one embodiment.

FIG. 2 is a perspective view in section of a first housing.

FIG. 3 is a perspective view of a first terminal fitting.

FIG. 4 is a side view in section when the first terminal fitting is incompletely inserted in a cavity.

FIG. 5 is a front view when the first terminal fitting is incompletely inserted in the cavity.

FIG. 6 is a side view in section when the first terminal fitting is properly inserted in the cavity.

FIG. 7 is a plan view showing a part of the first housing when the first terminal fitting is properly inserted in the cavity.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The connector of the present disclosure is provided with a terminal fitting and a housing for accommodating the terminal fitting, wherein the housing includes a cavity, the terminal fitting being arranged inside the cavity, and a deflectable locking lance projecting into the cavity to lock the terminal fitting, the locking lance includes a protrusion projecting toward a side opposite to the cavity, and the protrusion has an elevation surface facing a front surface side of the housing with the locking lance deflected.

If the terminal fitting is left incompletely inserted in the cavity, the locking lance is pressed by the terminal fitting and deflected toward the side opposite to the cavity, and the elevation surface of the protrusion faces the front surface side of the housing. Thus, by the contact of a detection jig (detection pin) with the elevation surface of the protrusion from front, it can be detected that the terminal fitting is in an incompletely inserted state. Particularly, since the elevation surface of the protrusion is configured to face the front surface side of the housing, the detection jig more easily contacts the elevation surface of the protrusion. Therefore, this connector can satisfactorily detect the incompletely inserted state of the terminal fitting by a simple configuration provided with the protrusion.

(2) Preferably, a surface of the locking lance opposite to the cavity, including the protrusion, is exposed on one surface of the housing.

According to this configuration, the protrusion can be easily manufactured. A degree of freedom in forming the protrusion can be enhanced.

(3) Preferably, the housing is a stacking housing, and a stacking partner is arranged to face the one surface of the housing.

According to this configuration, when the housing is stacked with the stacking partner, the stacking partner can protect the protrusion.

(4) Preferably, the elevation surface is a surface rising vertically upward or inclined forward.

According to this configuration, the detection jig can more reliably contact the elevation surface.

(5) Preferably, the protrusion has a rear surface facing rearward on a side opposite to the elevation surface, and the rear surface of the protrusion is located forward of a base end portion of the locking lance.

According to this configuration, the deflection strength of the locking lance can be prevented from becoming excessive by the presence of the protrusion.

(6) Preferably, the base end portion of the locking lance includes a padded portion having a partially padded shape.

According to this configuration, the deflection strength of the locking lance can be adjusted by the padded portion.

(7) Preferably, the locking lance includes a slide-contact portion configured to interfere with the terminal fitting on one widthwise side, and the protrusion is provided on another widthwise side of the locking lance.

According to this configuration, the one widthwise side of the locking lance can be made relatively thinner than the other widthwise side including the protrusion. Thus, the one widthwise side of the locking lance is more easily deflected and deformed when interfering with a stabilizer or the like (part configured to interfere with the slide-contact portion) of the terminal fitting.

### DETAILS OF EMBODIMENT OF PRESENT DISCLOSURE

### Embodiment

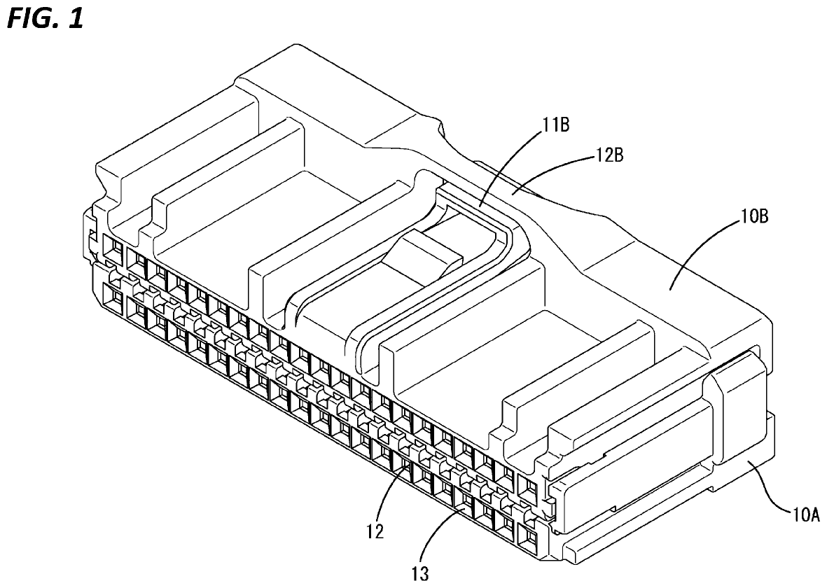

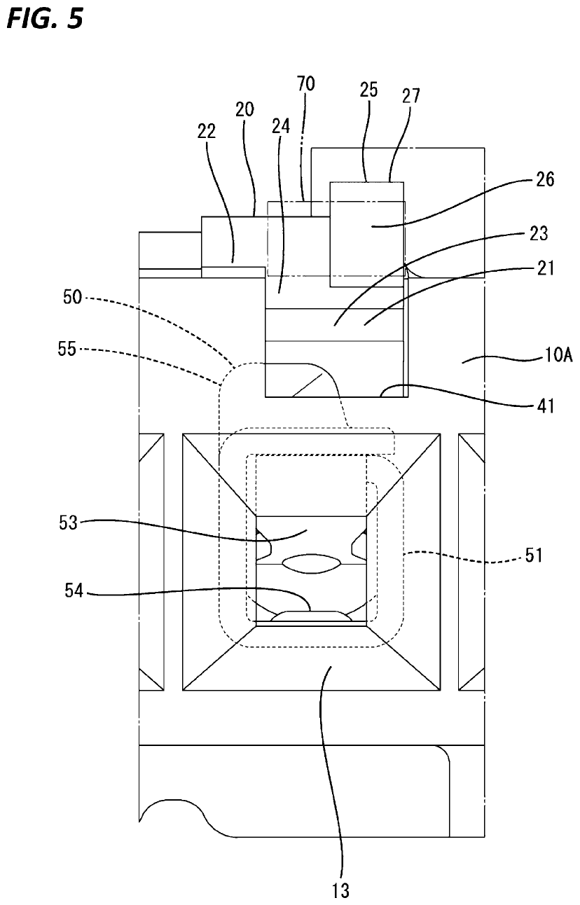

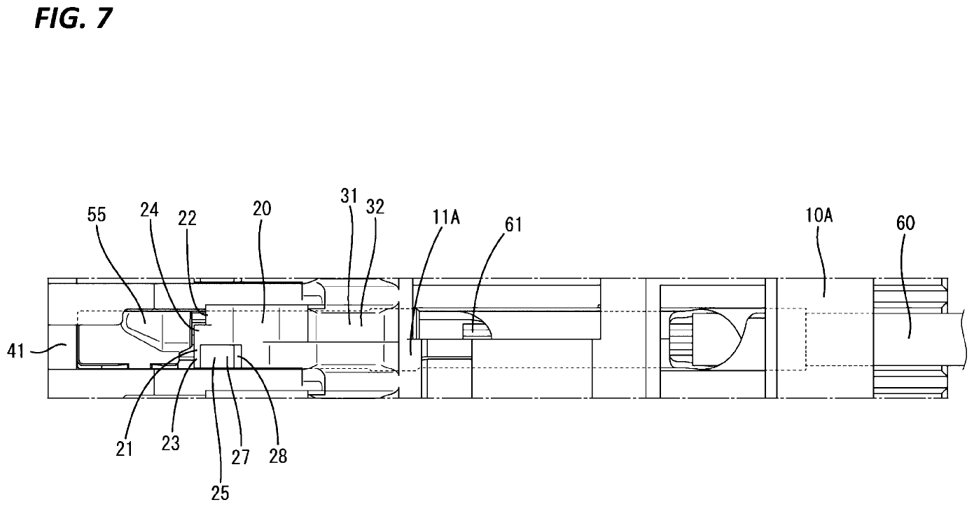

One specific embodiment of the connector of the present disclosure is described with reference to FIGS. 1 to 7. In this embodiment, left and right sides in FIGS. 1 to 4, 6 and 7 are referred to as front and rear sides concerning a front-rear direction. Upper and lower sides shown in each figure are directly defined as upper and lower sides concerning a vertical direction. Left and right sides shown in FIG. 5 are directly defined as left and right sides concerning a lateral direction.

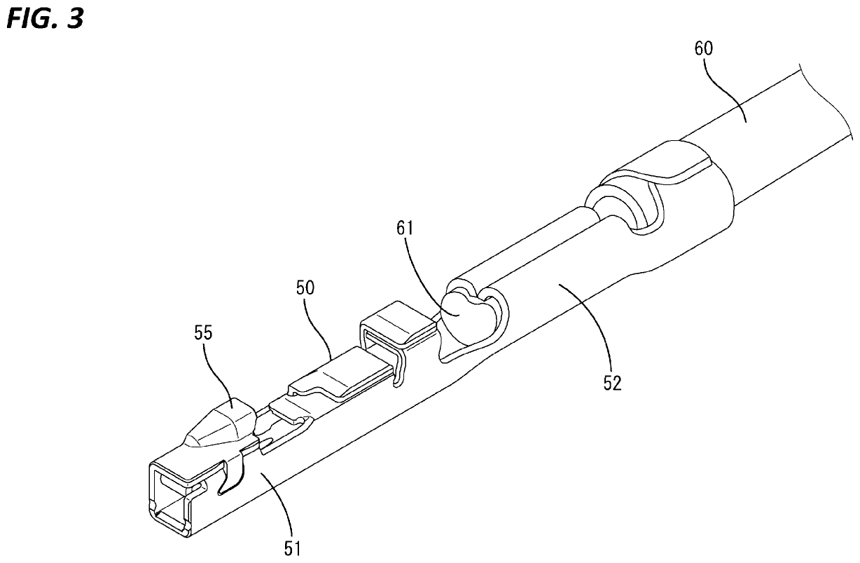

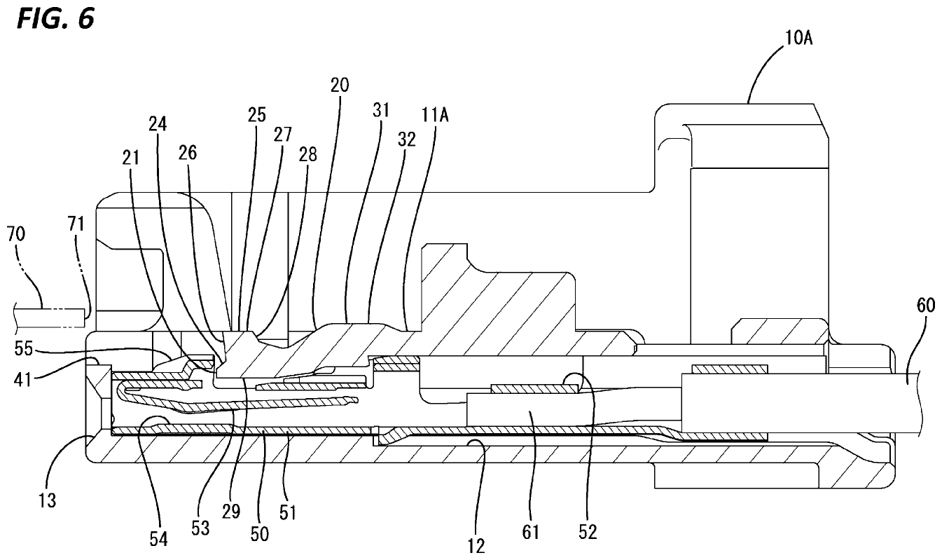

The connector of this embodiment includes a first housing 10 and a second housing 10B, which are stacking housings and to be stacked on each other as shown in FIG. 1, a plurality of first terminal fittings 50 (see FIGS. 3 and 6) and a plurality of second terminal fittings (see FIG. 3) to be respectively accommodated into the first housing 10A and the second housing 10B.

The first housing 10A is a lower housing located on a lower side, has a flat shape long in the lateral direction, and has a first facing surface 11A (one surface) facing the second housing 10B as a stacking partner on an upper surface. The first housing 10A includes a plurality of cavities 12 into which the first terminal fittings 50 are insertable. The respective cavities 12 are arranged side by side in one row in the lateral direction.

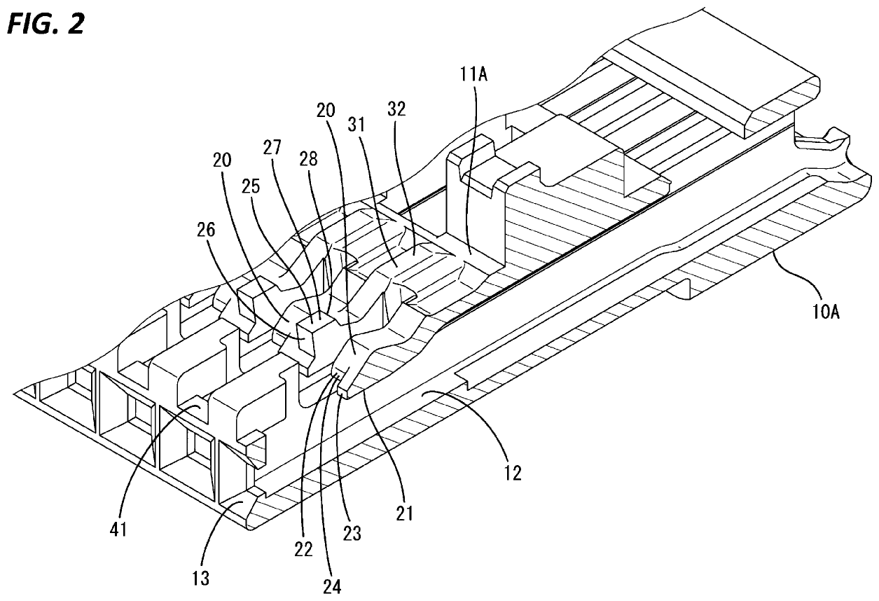

As shown in FIG. 2, the first housing 10A includes a plurality of insertion openings 13 communicating with the respective cavities 12 in a front wall part. When the connector is connected to an unillustrated mating connector, tabs of unillustrated mating terminal fittings mounted in the mating connector enter the corresponding cavities 12 through the respective insertion openings 13.

As shown in FIG. 2, the first housing 10A includes locking lances 20 cantilevered forward from central parts in the front-rear direction of the cavities 12 at positions corresponding to the respective cavities 12. The upper surface of each locking lance 20 is entirely exposed on the first facing surface 11A. The locking lance 20 projects into the cavity 12. The locking lance 20 is deflectable to project toward the first facing surface 11A. The locking lance 20 resiliently locks the first terminal fitting 50 inserted into the cavity 12 and retains the first terminal fitting 50.

As shown in FIG. 2, the locking lance 20 includes a tip portion 21 extending toward a front-lower side. The tip portion 21 has a first tip surface 22 and a second tip surface 23. The first tip surface 22 constitutes a surface on one widthwise side (left side) of the tip portion 21. The first tip surface 22 is recessed rearward with respect to the second tip surface 23. The first tip surface 22 is an arcuately curved surface. The second tip surface 23 constitutes a surface on the other widthwise side (right side) of the tip portion 21. The second tip surface 23 is a bent surface. On the one widthwise side (left side) of the tip portion 21 of the locking lance 20, a locking portion 24 is constituted by the first tip surface 23 and a left part of the second tip surface 23. The locking portion 24 locks the first terminal fitting 50 inserted to a proper insertion position in the cavity 12.

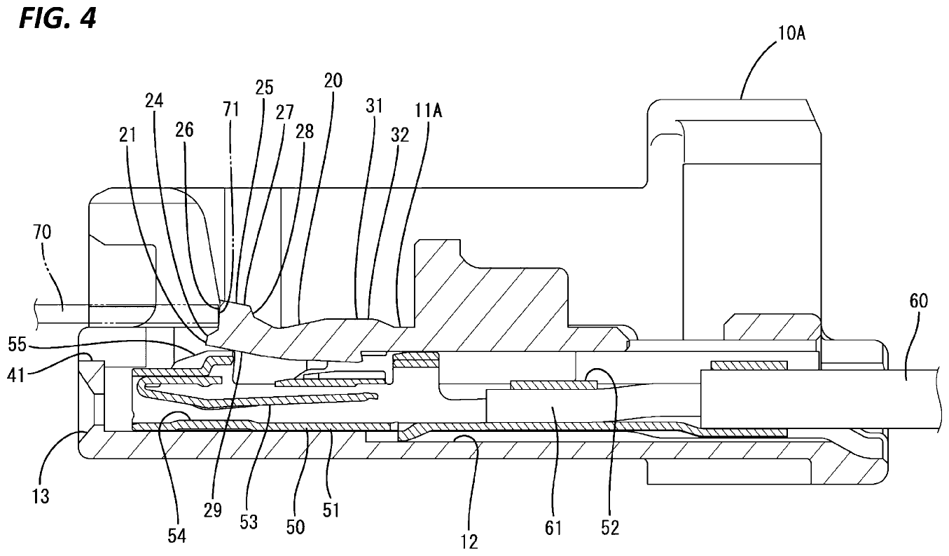

As shown in FIG. 2, the locking lance 20 includes a protrusion 25. The protrusion 25 is provided on the other widthwise side (right side) of the locking lance 20. The protrusion 25 is in the form of a rectangular block. The protrusion 25 projects toward a side (upper side) opposite to the locking portion 24 in the locking lance 20. A surface of the locking lance 20 opposite to the locking portion 24, including the protrusion 25, is exposed on the first facing surface 11A of the first housing 10A. The protrusion 25 has an elevation surface 26 rectangular in a front view and an upper surface 27 rectangular in a plan view. The elevation surface 26 rises upward from a right side part of the second tip surface 23. As shown in FIG. 6, the elevation surface 26 is a surface inclined forward in a state where the locking lance 20 is not deflected. As shown in FIG. 4, the elevation surface 26 faces the front surface side of the first housing 10A with the locking lance 20 deflected upward.

As shown in FIGS. 4 and 6, the protrusion 25 has a rear surface 28 facing rearward on a side (rear side) opposite to the elevation surface 26. The rear surface 28 is connected to a rear side of the upper surface 27. The rear surface 28 is located forward of a base end portion 31 of the locking lance 20. The base end portion 31 includes a partially padded rib-like padded portion 32. The padded portion 32 has a larger vertical thickness than a part of the locking lance 20 laterally adjacent to the padded portion 32.

The locking lance 20 includes a slide-contact portion 29 (see FIG. 4) configured to interfere with the first terminal fitting 50 when the first terminal fitting 50 is inserted into the cavity 12. The slide-contact portion 29 constitutes one widthwise side (left side) of the lower surface of the tip portion 21.

As shown in FIG. 2, the first housing 10A includes openings 41 in the form of recessed grooves open in the front surface on the upper end of the front wall. As shown in FIGS. 4 to 7, the openings 41 are located in front of the locking lances 20. The openings 41 are formed by removing a mold for forming the elevation surfaces 26. A groove width of the opening 41 is wider than a width of a detection jig 70 to be described later. The detection jig 70 can enter the opening 41 within a tolerance (assembling error) range. The elevation surface 26 is exposed to the front surface side of the first housing 10A through the open 41.

As shown in FIG. 3, the first terminal fitting 50 is a so-called female terminal fitting. The first terminal fitting 50 is integrally formed, such as by bending, after a conductive metal plate is stamped into a predetermined shape. The first terminal fitting 50 is elongated in the front-rear direction as a whole and includes a body portion 51 and a barrel portion 52 located behind the body portion 51. The barrel portion 52 is in the form of an open barrel and crimped and connected to a core portion 61 of a wire 60.

As shown in FIG. 3, the body portion 51 is in the form of a rectangular tube. As shown in FIGS. 4 and 6, the body portion 51 includes a resilient contact piece 53 and a receiving portion 54. The resilient contact piece 53 is formed by folding a tongue piece projecting from an upper plate of the body portion 51 rearward, and deflectable and deformable. The upper plate is configured by placing two inner and outer (upper and lower) plate materials on each other. The receiving portion 54 is provided at a position facing the resilient contact piece 53 on a bottom plate of the body portion 51. The receiving portion 54 is recessed to bulge toward the upper plate of the body portion 51. A male tab of the unillustrated mating terminal fitting is press-fit between the resilient contact piece 53 and the receiving portion 54, thereby being electrically connected to the first terminal fitting 50.

As shown in FIG. 3, the upper plate of the body portion 51 is provided with a stabilizer 55 at a position behind a front end. The stabilizer 55 is provided at a position near a left side on the upper plate of the body portion 51. The stabilizer 55 is formed to bulge upward by striking the upper plate of the body portion 51 from inside by a press. The stabilizer 55 has a trapezoidal shape in a front view and has such an outer shape that an upper part is connected to left and right sides in a curved manner.

The second housing 10B is an upper housing located on an upper side and, as shown in FIG. 1, has a flat shape long in the lateral direction and has a second facing surface (not shown) facing the first housing 10A as a stacking partner on a lower surface. The second housing 10B includes a cantilevered and deflectable lock arm 11B in a laterally central part of an upper surface. The second housing 10B includes a covering wall 12B extending over to cover a rear end part of the lock arm 11B. The covering wall 12B restricts the action of an unnecessary releasing force on the lock arm 11B.

The second housing 10B includes cavities formed similarly to the cavities 12, insertion openings (not shown) formed similarly to the insertion openings 13 and locking lances (not shown) formed similarly to the locking lances 20. If the first housing 10A and the second housing 10B are stacked, the locking lances 20 and the locking lances of the second housing 10B are arranged back-to-back.

Next, a process of mounting the first terminal fittings 50 into the first housing 10A is described. The first terminal fitting 50 is inserted into the cavity 12 from behind the first housing 10A. In an insertion process, the upper surface (stabilizer 55) of the first terminal fitting 50 interferes with the slide-contact portion 29 of the locking lance 20. Thus, the locking lance 20 is resiliently displaced to a side (upper side) opposite to the cavity 12. A state where the locking lance 20 is resiliently displaced toward the first facing surface 11A (side toward which the second housing 10B is stacked) without the first terminal fitting 50 reaching a proper insertion position as shown in FIG. 4 is defined as an incompletely inserted state.

When the first terminal fitting 50 reaches the proper insertion position as shown in FIG. 6, the locking lance 20 resiliently returns toward the cavity 12 and the locking portion 24 locks the first terminal fitting 50. The first tip surface 22 can enter below the stabilizer 55. The locking portion 24 (first tip surface 22 and the one widthwise side (left side) of the second tip surface 23) can simultaneously contact the rear end of the stabilizer 55. In this way, the first terminal fitting 50 is retained and held in the first housing 10A. A state where the first terminal fitting 50 is at the proper insertion position and retained by the locking lance 20 is defined as a properly inserted state.

Whether or not the first terminal fitting 50 is in the incompletely inserted state is detected using the detection jig (detection pin) 70. As shown in FIG. 5, the detection jig 70 is inserted into the first housing 10A at the same height as the upper surface of the opening 41 from front. Note that, even if the detection jig 70 is slightly inclined downward, interference with the front wall of the first housing 10A can be avoided by the entrance of the tip of the detection jig 70 into the opening 41. If the first terminal fitting 50 is in the properly inserted state, the protrusion 25 of the locking lance 20 does not project further upward than the opening 41 as shown in FIG. 6. Thus, the detection jig 70 can pass rearward above the locking lance 20 without contacting the elevation surface 26 of the protrusion 25. In this way, it can be known that the first terminal fitting 50 is not in the incompletely inserted state, i.e. the first terminal fitting 50 is in the properly inserted state.

In contrast, if the first terminal fitting 50 is left incompletely inserted in the cavity 12 as shown in FIG. 4, the locking lance 20 is pressed by the first terminal fitting 50 and deflected toward the side (upper side) opposite to the locking portion 24. In this way, the protrusion 25 of the locking lance 20 projects further upward than the opening 41. Then, the elevation surface 26 of the protrusion 25 faces the front surface side of the first housing 10A while extending along the vertical direction (direction orthogonal to an inserting direction of the first terminal fitting 50 into the first housing 10A, more specifically direction orthogonal to the inserting direction and an arrangement direction of the first terminal fittings 50). Thus, the detection jig 70 inserted into the first housing 10 via an upper part of the opening 41 from front contacts the elevation surface 26 of the protrusion 25 from front. In this way, it can be detected that the first terminal fitting 50 is in the incompletely inserted state. At this time, a tip surface (detection surface) 71 of the detection jig 70 comes into surface contact with the elevation surface 26.

As described above, in the connector of the present disclosure, if the first terminal fitting 50 is left incompletely inserted in the cavity 12, the locking lance 20 is pressed by the first terminal fitting 50 and deflected toward the side opposite to the cavity 12, and the elevation surface 26 of the protrusion 25 faces the front surface side of the first housing 10A. Thus, the detection jig (detection pin) 70 contacts the elevation surface 26 of the protrusion 25 from front, whereby it can be detected that the first terminal fitting 50 is in the incompletely inserted state. Particularly, since the elevation surface 26 of the protrusion 25 is configured to face the front surface side of the first housing 10A, the detection jig 70 is easily brought into contact. Therefore, this connector can satisfactorily detect the incompletely inserted state of the first terminal fitting 50 by a simple configuration provided with the protrusion 25.

In the connector of the present disclosure, the surface of the locking lance 20 opposite to the cavity 12, including the protrusion 25, is exposed on the first facing surface 11A of the first housing 10A. In this way, the protrusion 25 can be easily fabricated. A degree of freedom in forming the protrusion 25 can be enhanced.

In the connector of the present disclosure, the first housing 10A is a stacking housing and the second housing 10B is arranged to face the first facing surface 11A of the first housing 10A. In this way, when the first housing 10A is in a state stacked with the stacking partner, the stacking partner can protect the protrusions 25.

In the connector of the present disclosure, the elevation surface 26 is a surface rising vertically upward with the locking lance 20 deflected. In this way, the detection jig 70 can more reliably contact the elevation surface 26.

In the connector of the present disclosure, the protrusion 25 has the rear surface 28 facing rearward on the side opposite to the elevation surface 26. The rear surface 28 of the protrusion 25 is located forward of the base end portion 31 of the locking lance 20. In this way, the deflection strength of the locking lance 20 can be prevented from becoming excessive by the presence of the protrusion 25.

In the connector of the present disclosure, the base end portion 31 of the locking lance 20 includes the padded portion 32 having a partially padded shape. According to this configuration, the deflection strength of the locking lance 20 can be adjusted by the padded portion 32.

In the connector of the present disclosure, the locking lance 20 includes the slide-contact portion 29 configured to interfere with the first terminal fitting 50 on the one widthwise side (left side). The protrusion 25 is provided on the other widthwise side (right) side of the locking lance 20. According to this configuration, the one widthwise side (left side) of the locking lance 20 can be made relatively thinner than the other widthwise side (right side) including the protrusion 25. Thus, the one widthwise side (left side) of the locking lance 20 is more easily deflected and deformed when interfering with the stabilizer or the like (part configured to interfere with the slide-contact portion 29) of the first terminal fitting 50.

### OTHER EMBODIMENTS

The present invention is not limited to the above described and illustrated embodiment and is represented by claims. The present invention is intended to include all changes in the meaning of equivalents to claims and in the scope of claims and include also the following embodiments.

In the above embodiment, the elevation surface 26 is orthogonal to the front-rear direction in the deflected state (incompletely inserted state of the first terminal fitting 50). However, the elevation surface 26 may be inclined forward (inclined upward toward the front) in the deflected state (incompletely inserted state of the first terminal fitting 50). Further, the elevation surface 26 may be inclined rearward (inclined downward toward the front) in the deflected state (incompletely inserted state of the first terminal fitting 50).

In the above embodiment, the first housing 10A is provided with the cavities 12 arranged in one row in the lateral direction in one stage. However, the cavities 12 may be provided in multiple stages in the vertical direction. The second housing 10B may also be similarly provided with the cavities 12 provided in multiple stages in the vertical direction.

Although the first housing 10A is configured such that the second housing 10B is stacked thereon in the above embodiment, the first housing 10A may be covered with a lid member.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a terminal fitting; and
a housing for accommodating the terminal fitting,
wherein:
the housing includes a cavity, the terminal fitting being arranged inside the cavity, and a deflectable locking lance projecting into the cavity to lock the terminal fitting,
the locking lance includes a protrusion projecting toward a side opposite to the cavity, and
the protrusion has an elevation surface facing a front surface side of the housing with the locking lance deflected.

2. The connector of claim 1, wherein a surface of the locking lance opposite to the cavity, including the protrusion, is exposed on one surface of the housing.

3. The connector of claim 2, wherein:
the housing is a stacking housing, and
a stacking partner is arranged to face the one surface of the housing.

4. The connector of claim 1, wherein the elevation surface is a surface rising vertically upward or inclined forward.

5. The connector of claim 1, wherein the protrusion has a rear surface facing rearward on a side opposite to the elevation surface, and the rear surface of the protrusion is located forward of a base end portion of the locking lance.

6. The connector of claim 5, wherein the base end portion of the locking lance includes a padded portion having a partially padded shape.

7. The connector of claim 1, wherein:
the locking lance includes a slide-contact portion configured to interfere with the terminal fitting on one widthwise side, and
the protrusion is provided on another widthwise side of the locking lance.
